(19) United States
(12) Patent Application Publication
(10) Pub. No.: US 2014/0317066 A1
(43) Pub. Date: Oct. 23, 2014

(54) METHOD OF ANALYSING DATA

(71) Applicant: Curtin University of Technology, Bentley (AU)

(72) Inventors: Fedja Hadzic, Victoria Park (AU); Michael Hecker, Bayswater (AU)

(73) Assignee: Curtin University of Technology, Bentley (AU)

(21) Appl. No.: 14/256,879

(22) Filed: Apr. 18, 2014

Related U.S. Application Data
(63) Continuation of application No. PCT/AU2012/001361, filed on Nov. 7, 2012.

(30) Foreign Application Priority Data
Nov. 7, 2011 (AU) 2011904616

(51) Int. Cl. G06F 17/30

(52) U.S. Cl. CPC G06F 17/30371; G06F 17/30598
USPC 707/690

(57) ABSTRACT

The present invention disclosure provides a method of analysing data. In a first step a plurality of data records is provided, each data record having a plurality of data elements and having a property. At least some data elements of each data record are selected. In a next step, the selected data elements are grouped in a plurality of groups such that each group has data elements that are a part of one of the data records and such that for a group that has data elements of more than one data record, each data element or property is similar or identical to at least one of the data elements or properties, respectively, of each other data record of that group. A group of interest and a reference group are determined from the plurality of groups. The group of interest has at least one data element of interest and the reference group has data elements or properties that are similar or identical with data elements or properties, respectively, of the group of interest. In a further step, the group of interest is compared with the reference group such that from the reference group information concerning the data element of interest can be derived.

### FIELD OF THE INVENTION

The present invention relates to a method of analysing data and relates particularly, though not exclusively, to a method of identifying and correcting errors in data records and to a method of reconstructing one or more business processes from data records.

### BACKGROUND OF THE INVENTION

Data records in a database entered by a user may include inaccurate, incorrect, incomplete or irrelevant data elements. Data cleansing is frequently performed to detect such data elements and correct or remove these data elements from data records stored in the database.

Techniques for cleansing data records are performed on an individual data element level. Typically statistical, clustering or inference based techniques are used, which all operate on the individual data element level. These techniques solely focus on cleansing of existing data records and have to be repeated when new data records are generated.

Such data cleansing processes need to be frequently re-applied as quality issues are likely to reoccur in an organisation, unless sources of the quality issues have been identified and effectively resolved.

### SUMMARY OF THE INVENTION

The present invention provides in a first aspect a method of analysing data, the method comprising the steps of:
providing a plurality of data records, each data record having a plurality of data elements and having a property;
selecting at least some data elements of each data record;
grouping the selected data elements in a plurality of groups such that each group has data elements that are a part of one of the data records and such that for a group that has data elements of more than one data record, each data element or each property is similar or identical to at least one of the data elements or properties, respectively, of each other data record of that group;
determining a group of interest of the plurality of groups, the group of interest having at least one data element of interest;
determining another group of the plurality of groups, the other group forming a reference group having data elements or properties that are similar or identical with data elements or properties, respectively, of the group of interest; and
comparing the group of interest with the reference group such that from the reference group information concerning the data element of interest can be derived.

In a specific embodiment the method of analysing data is implemented by a computer program. The computer program may be arranged when loaded into a computer system to instruct the computer system to operate in accordance with a method of analysing data.

For example, the plurality of data records may be data records entered into a computer system such as audit logs, client data, financial data and/or demographic data. The plurality of data records may have a definite order such as a time order when data records are entered into a computer system. The plurality of data records may be entered by a user or may be generated in response of an activity by a user.

The data elements of the plurality of data records may comprise characters, numbers or any other suitable type of symbols.

In one embodiment, each data record is associated with a business process instance. The step of grouping the selected data elements in a plurality of groups may be conducted such that the plurality of groups is associated with a business process. Each group may be associated with a plurality of instances of the business process and the plurality of instances associated with a group may form an execution path of the business process. A group may, for example, be associated with one or more transactions, a specific work flow sequence, or a specific transaction of a business process such as an activity as, for example, adding a new client, developing a product, or a financial transaction.

In one embodiment, the information concerning the data element of interest is indicative of information concerning the plurality of instances of the business process associated with the group of interest.

In a specific embodiment, the method of analysing data is conducted such that one or more business processes can be reconstructed. For example, the method may comprise a further step of analysing at least some of the plurality of groups to reconstruct one or more business processes associated with the plurality of groups. Additionally, the method may be conducted such that a business rule associated with the one or more business processes can be identified.

Business processes may comprise a plurality of related, structured activities or tasks which produce a specific service or product. Typically, each group of the plurality of groups may relate to one or more of the following: activities or tasks of the business process, business process instances such as adding a new client comprising all steps or activities for executing the business process, users of the business process such as employees and time periods.

In one embodiment, the at least one data element of interest may be associated with an undesired or unexpected process instance. In one particular example, the at least one data element of interest may be associated with an override, which may or may not be a result of an error.

An undesired or unexpected process instance such as an override may be a result of a violation of a rule. In one embodiment, a rule may be implemented in the form of a validation alert that is communicated to a user.

For example, a business process may relate to “adding a new client to a database” and one business process instance relates to a search for an existing client with similar or identical details. If the outcome of the search is positive, a validation alert will be communicated to the user with the existing client details. An override will be introduced, if the user ignores the validation alert and adds the new client.

In a specific embodiment, the at least one data element of interest is associated with an error such as an inconsistency or a duplicate. For example, an inconsistency may be a result of an incorrect entry of a word or an entry of data elements in an incorrect order. A duplicate may be a result of a multiple entry of a data element or data record. This may be a result of the use of an abbreviation or an inconsistent order of data elements.

In one embodiment, the step of selecting at least some data elements of each data record comprises selecting the entire data record.

In one embodiment, the property of the data record relates to one of the data elements of the data record. In a further embodiment, the data record has a plurality of properties that relate to the respective plurality of data elements of the data record. The property may, for example, be a type such as “time stamp”, “name”, “country”, “user”, “description”. Further, the property may be a position of a data element within a data record or a position of the data record within an execution path of a business process or a time order when a user entered the data element or the data record. Additionally or alternatively, the property may be a sequence or range of numbers or characters. For example, the property may be a range of numbers in a particular unit such as inches or centimetres. Alternatively, the property may be characters associated with, for example, a country, a city or a name.

In a specific example, a property may be associated with a rule. For example, if a data element or a data record is inconsistent with a property associated with the data element or the data record, the rule may be violated.

In one specific embodiment, the step of comparing the group of interest with the reference group comprises analysing the information concerning the data element of interest such that an origin or cause of the data element of interest can be identified.

In one embodiment, the information is indicative of characteristics of the group of interest and/or characteristics of process instances that are associated with the group of interest. The reference group may relate to process instances that reflect data elements or properties as expected. The group of interest may relate to an undesired or unexpected process instance such as an override. The step of comparing the group of interest with the reference group may identify specific characteristics of the process instance or insufficient system logic that causes the at least one data element of interest.

The origin or cause of the data element of interest may be incorrect data entry such as misspellings, missing numbers, duplicates, rules which may be inadequate, violations of rules, a data entry system which needs to be updated and/or potential fraud, at least.

The step of comparing the group of interest with the reference group may comprise determining a correction of the data element of interest. The correction may be communicated to a user.

Additionally or alternatively the step of comparing the group of interest with the reference group may comprise determining a rule for the correction of the undesired or unexpected process instance and/or the correction of the data element of interest. The rule may be added to the computer system.

In one embodiment, the step of comparing the group of interest with the reference group comprises determining characteristics of an execution path of a business process. The characteristics may form rules. The rules may be communicated to a user and/or added to the computer system. In particular, if the method comprises the step of analysing the information concerning the data element of interest to reconstruct one or more business processes associated with the plurality of groups, the method may further comprise a step of determining a business rule from the reconstruction of the one or more business processes.

In one specific embodiment, the step of comparing the group of interest with the reference group comprises determining an origin or cause of the data element of interest, the correction of the data element of interest and determining a rule for the correction of a data element of interest having a specific origin or cause.

In one specific embodiment, each group of the plurality of groups has data elements that are a part of one of the data records and each data element is similar or identical to one of the data elements of each other data record of that group. For example, a group of selected data elements may comprise a total of 30 selected data elements that form a part of 10 data records. In this example 3 of the data elements are part of one data record. The 3 data elements may comprise first name, middle name and surname. The 3 data elements being similar or identical to corresponding data elements of each other data record of that group and consequently the first name, middle name and surname of each data record is similar or identical to the first name of each other data record.

The method of analysing data may comprise an additional step of comparing the group of interest with predetermined rules to analyse if rules associated with the group of interest are violated.

In one embodiment, the predetermined rules are stored in a database. The rules may relate to business rules and/or organisational policies and/or identified general rules for the correction of undesired or unexpected process instances and/or a data element of interest having a specific cause or origin.

A rule for the correction of a data element of interest having an identified specific cause or origin may be added to the database.

Embodiments of the present invention provide significant advantages for resolving data quality issues. Data records usually need to conform to any organisational policies and rules that reflect standard organisational workflow and are incorporated into the data cleansing process. As data records may comprise incorrect or unexpected data elements, a data cleansing process needs to be performed. Embodiments of the present invention will result in a more efficient data cleansing process that is not necessarily performed on the individual data element level. In addition, any violations or inconsistencies in the existing standard workflow will be detected and linked back to a particular data quality issue caused by them.

In one embodiment, the step of grouping the selected data elements in a plurality of groups comprises characterising each group by the selected data elements or properties within each group and/or by the associated business process instances or path and/or by a combination of both. Additionally, a user may select any number of groups to determine similarities and/or differences between the selected groups. Further, the user may select a relation of similarity and/or difference between the selected groups to determine the group of interest and the reference group.

For example, the step of grouping the selected data elements in a plurality of groups may be conducted using a clustering based approach.

Throughout the specification, the term “clustering” is used to refer to a specific process of grouping such that data records within a group or the properties of the corresponding data elements have a maximum similarity while data records in different groups or the properties of the corresponding data elements have a maximum dissimilarity.

In one embodiment, the method of analysing data comprises selecting a group of interest by a user, the group of interest having at least one data element of interest. Alternatively or additionally, the method may comprise selecting another group forming a reference group by a user.

In a particular embodiment, the step of determining a group of interest having at least one data element of interest and/or determining another group forming a reference group may comprise determining a size of each group of the plurality of groups or a frequency of the data records or the selected data elements of the respective data records in each group.

In a specific embodiment, the step of comparing a group of interest having at least one data element of interest with a reference group is performed using a “similarity matrix”. The concept of using a “similarity matrix” may comprise comparing each group of the plurality of groups with each other group of the plurality of groups such that two most similar groups can be identified. Subsequently, data elements or properties of the two most similar groups may be compared to each other such that an origin and/or correction of the data element of interest can be identified.

The method may comprise an additional step of detecting and correcting data records comprising duplicates such that data records comprising a duplicate are merged into a corresponding data record.

In a specific embodiment, the step of determining a group of interest having at least one data element of interest comprises identifying at least one undesired or unexpected process instance such as an override. The method may also comprise an additional step of analysing the information concerning the at least one data element of interest associated with an undesired or unexpected process instance such that a validity of the undesired or unexpected process instance is determined.

The information may be associated with a sequence of process instances causing the at least one data element of interest.

If an undesired or unexpected process instance is determined as an invalid process instance, the at least one data element of interest or the data record associated with the undesired or unexpected process instance may be corrected and the corresponding rule which may be implemented as a validation alert may be enforced or updated.

Alternatively, if an undesired or unexpected process instance is determined as a valid process instance, the corresponding rule which may be implemented as a validation alert may be removed or updated.

In one embodiment, the method of analysing data may be performed using “tree mining”.

In one specific embodiment, the step of grouping the selected data elements in a plurality of groups and comparing the group of interest with the reference group may be performed using “tree mining”. The concept of “tree mining” is a specific type of structured data mining such as XML. “Tree mining” may comprise representing the plurality of data records in a tree structured format so as to reduce the size of the plurality of data records and to analyse the tree structured format using common tree mining algorithms.

In one embodiment of the present invention, a root of a tree is associated with a specific business process or a transaction. A node of the tree may represent a data element or a data record or a property of a data element. Branches of the tree may represent finite parts of execution paths of a business process or a particular transaction. A subtree may refer to a group of the plurality of groups such as business process instances.

A significant advantage of using the concept of tree mining in accordance with an embodiment of the invention is that the plurality of data records are represented in a tree structured format which is simple to understand and interpret, requires little data preparation and can handle numerical and categorical data. In addition, the tree structured format preserves an order and a position in which the plurality of data records and the respective data elements were entered into a computer system. Also, this information is further preserved in knowledge patterns such as subtrees that may be associated with the plurality of groups. As such, business processes and business process execution paths including corresponding business process instances can be reconstructed from analysing the tree structured format. For example, characteristics of the groups that may be associated with respective business process instances may be efficiently contextualised and ordered for the step of comparing the group of interest with the reference group.

In one specific example, a first tree will be generated for a specific business process. A business process may comprise a plurality of transactions, which can also be represented by a plurality of secondary trees connected to the first tree. Each tree may comprise subtrees, which are associated with the plurality of groups such as business process instances. Each tree or subtree may comprise a plurality of nodes which is associated with data elements, data records or properties of respective data elements. Using the concept of tree mining may comprise identifying all subtree patterns in the tree structured format such that characteristics of the plurality of groups may be identified. The step of comparing the group of interest with the reference group may comprise comparing the identified characteristics of the group of interest with the identified characteristics of the reference group.

In another specific embodiment, the step of grouping the selected data elements in a plurality of groups is performed using “sequence mining”.

In one specific embodiment the method of analysing data is performed in a sequence of the following steps:
detecting a group of interest having a data element of interest comprising at least one inconsistency; thereafter
correcting the at least one inconsistency; thereafter
detecting duplicates; thereafter
removing duplicates; thereafter
identifying overrides; thereafter
identifying business processes as origins of the
identified overrides; and thereafter
correcting the identified business processes and/or remove or update the corresponding validation alert.

In accordance with a second aspect of the present invention, there is provided a computer program arranged when loaded into a computer system to instruct the computer system to operate in accordance with the method of the first aspect of the present invention.

In accordance with a third aspect of the present invention, there is provided a computer readable medium for causing a computer system to operate in accordance with a method of the first aspect of the present invention.

The present invention provides in a fourth aspect a method of analysing data, the method comprising the steps of:
providing a plurality of data records, each data record being associated with an instance of a business process and having a property;
grouping the plurality of data records in a plurality of groups such that the plurality of groups is associated with a business process, each group being associated with a plurality of instances of the business process, and the property of each data record in a group being similar or identical to a property of each other data record of that group;
determining a group of interest of the plurality of groups, the group of interest having at least one data record of interest which is associated with an undesired or unexpected business process instance;
determining another group of the plurality of groups, the other group forming a reference group having data records that have respective properties which are similar or identical with properties of respective data records of the group of interest; and
comparing the group of interest with the reference group such that from the reference group information concerning the data record of interest and/or the plurality of instances associated with the group of interest can be derived.

The invention will be more fully understood from the following description of specific embodiments of the invention. The description is provided with reference to the accompanying drawings.

### BRIEF DESCRIPTION OF THE DRAWINGS

FIG. 1 shows a schematic representation of a method of analysing data in accordance with an embodiment of the present invention;

FIGS. 2 and 3 show schematic representations of grouping and comparing groups of data records in accordance with a specific embodiment of the present invention;

FIGS. 4A and 4B illustrate the concept of “tree mining” in accordance with an embodiment of the present invention.

### DETAILED DESCRIPTION OF SPECIFIC EMBODIMENTS

Embodiments of the invention provide a method of analysing data, in particular, of analysing data records and for reconstructing one or more business processes including execution paths of a business process and corresponding business process instances from the data records.

Embodiments of the method may be implemented by a computer program of a computer based system.

In a first step, a plurality of data records having respective data elements is provided. Each data record may be associated with a business process instance, an event or an activity within the business process. The data records may, for example, be audit logs, client data, financial data and/or demographic data. The data records may or may not have a time stamp which is indicative of the order the data elements and/or records were entered into the system.

Each data record also has at least one property. For example, the at least one property may relate to one of the data elements of the data records. In one embodiment, each data element has a property. The property may be a category such as “time stamp”, “user”, “name”, “country”, “city” or any other suitable category. The property may alternatively be a type such as characters or numbers or a combination of both, a range of numbers or any other suitable type.

In a next step, a selection process may be conducted in which data elements of each data record are selected.

In one embodiment, the entire data record is selected. The plurality of data records are then grouped into a plurality of groups such that the plurality of groups is associated with a business process and each group is associated with a plurality of business process instances such as a workflow sequence, or a finite execution path of the business process. Further, a property of each data record in a group is similar or identical to a property of each other data record of that group. Thus, by comparing at least some of the plurality of groups, a business process or specific instances of a business process can be reconstructed.

From the plurality of groups, a group of interest and a reference group are determined. The reference group may reflect normal workflow that leads to correct data records having respective data elements whereas the group of interest may reflect an undesired or unexpected workflow that may lead to data pollution. The group of interest may, for example, be associated with an undesired or unexpected process instance such as an override by a user. Additionally or alternatively, the data records of the group of interest may include invalid data elements or data records such as inconsistencies, and/or duplicates.

The group of interest and the reference group are compared with each other to derive information from the reference group concerning the data record of interest and optionally the group of interest. The information may concern a particular data record or a data element of interest of the group of interest. In this way, problems with the business process or the instances that form a work flow may be identified and it is possible to modify the business process or the work flow to solve the problems.

Business processes typically conform to rules such as business rules or policies. As a further step of the above described method, rules may be identified from the reconstructed business process and added to the computer system or if necessary predetermined rules may be removed or updated.

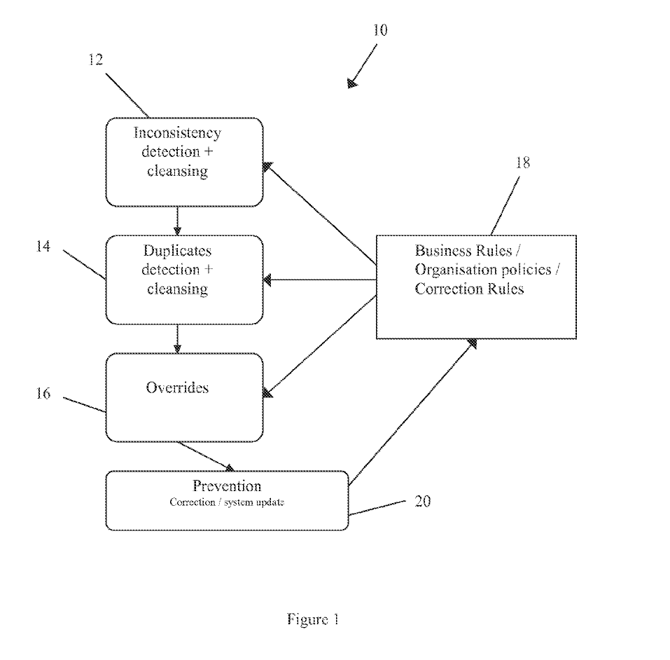

Referring initially to FIG. 1, there is shown a method of analysing data 10 in accordance with a specific embodiment of the invention. The method relates particularly to a cleansing process of data records associated with business processes entered into a computer system.

The method of analysing data 10 may comprise one or more of the following illustrated steps in accordance with embodiments of the present invention. The method 10 may start with detecting groups of data elements comprising at least one inconsistency 12 and correcting the detected groups. Subsequently, groups having data elements comprising duplicates are detected 14 and merged into a corresponding primary data record. In a third step 16, groups of data elements associated with overrides as a specific example for an unexpected or undesired business process instance are detected. The overrides may be a consequence of a violation of a rule that may be implemented as a validation alert which was ignored by a user. In addition, the validity of the overrides will be determined as either valid or invalid.

Performing the three steps optionally includes a step of comparing the detected groups of data elements with predetermined rules 18 such as business rules, organisational policies or rules on how to correct errors of a specific origin.

The rules reflect standard organisational workflow and standards that current data records or elements should conform to. This optional step is typically implemented by the computer program as a standardisation of how a data element needs to be entered into the system. In particular, data elements of a data record entered into the system need to conform to the rules, such as an expected property of the data elements.

For example, a plurality of data records is entered into a system. Each data record relates to client data comprising name, street address, city and country. A limitation to the country data element would for example be a drop-down list of selected countries. Typically, a validation alert is communicated to a user if the entered data element does not conform to the rules. Usually, the computer system will allow a user with certain privileges to ignore a validation alert, which results in an override.

Incorporating this optional step (comparing the detected groups of data elements with rules) into a data cleansing process benefits in multiple ways: the data cleansing process will be more effective as detection and resolution strategies are better oriented towards a specific standard workflow and any violations of rules, inconsistencies or duplicates in the existing workflow, organisational policies or business rules will be detected and can be linked back to a particular data quality issue which causes them. An update of the rules such as a workflow execution path or system logic can subsequently be performed in order to resolve specific origins of data quality issues.

In order to identify the validity of groups having at least one data element associated with an override, the group will be compared to the rules described above.

In addition to the third step of detecting a group comprising at least one data element associated with an override 16, origins and the validity of the override are identified by comparing the group with the rules and with the group forming the reference group. The reference group is associated with the same business process and/or the same independent transaction, wherein the same business process or transaction is reflected but no override has occurred. This group may reflect standard business operations, for example, where no rule was violated and therefore no validation alert was communicated to a user.

Once the validity of an override is identified as valid or invalid, origins of the override may further be analysed to determine if the corresponding validation alert needs to be updated or removed or if the group having at least one override needs to be corrected.

For example, an origin of an override of the group of interest may relate to a specific user who is associated with frequent overrides. In case of invalid overrides, this could indicate a potential fraud.

In addition to the steps of correcting inconsistencies, duplicates and/or data elements associated with overrides, a correction rule may be generated for specific origins of these inconsistencies, duplicates and/or overrides. Therefore, data quality issues will be linked back to particular origins which cause the respective inconsistencies, duplicates and/or overrides. Embodiments of the present invention will provide resolution strategies to extinguish these origins and ensure high quality of newly entered data records.

A monitoring phase (not shown) may involve the application of all three steps in order to determine whether any data quality issues are present for existing and newly entered data records. The monitoring process may further involve evaluation of changes to business rules and/or system logic updates.

After performing the method of analysing data in accordance with an embodiment of the present invention, the occurrence of validation alerts due to inconsistencies or duplicates will be minimised. In addition, incorporated correction rules will minimise overrides as users may only be allowed to enter data elements which conform to the updated rules.

Detecting inconsistencies is a necessary requirement to improve the level of data quality in a computer system. Inconsistencies are related to, for example, misspellings, missing values, contradictions, or any violations of rules such as business rules, organisational policies or correction rules.

For example, inconsistencies may occur vertically or horizontally in a table comprising a plurality of data records. A vertical inconsistency, for example a column of a table, may refer to an inconsistency with respect to the property of one data element. A horizontal inconsistency, for example a row of a table, may be an invalid or inconsistent combination of data elements of a data record. Properties of the data elements may be correct and consistent but the combination within the data record may be invalid or inconsistent. Detecting and correcting vertical inconsistencies need to be performed before horizontal detection can proceed.

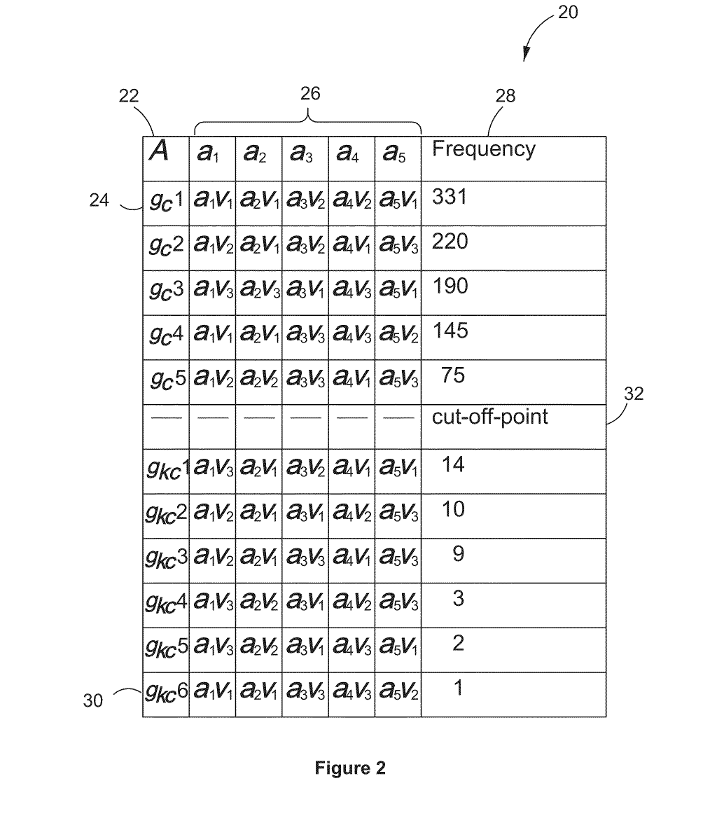

Referring now to FIG. 2, there is shown a specific embodiment of the method of analysing data to detect an inconsistency. The selected data elements are grouped into eleven groups represented in a table 20, namely g_{c}1 to g_{c}5 and g_{ic}1 to g_{ic}6 as shown in column A 22. Each group of the eleven groups comprises data records having data elements that are identical with data elements of each other data record of that group.

A threshold is predefined which is related to the frequency of data records in a group. The threshold may be selected by a user and/or may be tuneable. If the frequency of data records in a group is below the threshold, the group is likely associated with data elements comprising at least one inconsistency. Alternatively, if the frequency of data records in a group exceeds the threshold and has data elements that are similar or identical with data elements of the group of interest, the group may form a reference group. However, a person skilled in the art will appreciate that the step of grouping may be conducted in any suitable manner. For example, the step of grouping may comprise characterising each group by data elements or properties contained within a group or by associated business process instances or path. A user may then select a number of groups to determine similarities and/or differences between the selected groups. Based on the similarities and/or differences, the user may further determine a group of interest and the reference group.

For example, group g_{c}1 24 consists of 331 data records, which is represented by the frequency 28, having five data elements a1 to a5 (a1=a1v1; a2=a2v1; a3=a3v2; a4=a4v2; a5=a5v1). The frequency 28 in this example is associated with the number of data records in the group. In particular, group g_{c}1 24 consists of 331 data records, whereas group g_{ic}6 30 only consists of one data record. The cut-off point 32 relates to a threshold of the number of data records and is set to 20 in this example. Assuming there are 1000 data records, the threshold is 2% of the total number of data records.

Each group having less than 20 data records is likely to be associated with a group having data records comprising of at least one inconsistency. Each group having more than 20 data records may be identified as reference group.

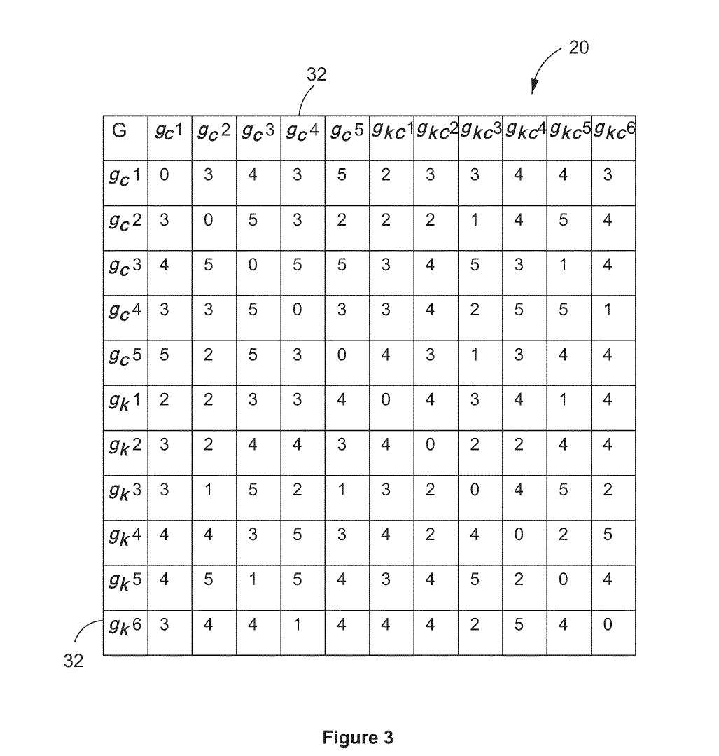

FIG. 3 illustrates the step of comparing a group of interest with a reference group using a “similarity matrix” in accordance with an embodiment of the present invention. The concept of using a similarity matrix 30 may comprise comparing each group of the plurality of groups with each other group such that the two most similar groups can be identified.

For example, selecting the group g_{ic}6 32 as a group of interest having data records comprising at least one inconsistency, the group g_{c}4 may be identified as a sufficiently similar group. The numbers shown in the cells of similarity matrix 30 are associated with the number of different data elements of two groups being compared to each other. A correction of the group g_{ic}6 32 may be identified by comparing data elements of the data records of group g_{ic}6 32 and group g_{c}4 34. In particular, the fourth data element of group g_{ic}6 (a4=a4v3) may be replaced by the fourth data element of the group g_{c}4 (a4v1). A correction of the data element having an inconsistency may be communicated to a user.

A user may confirm whether the correction of a data element or of a group of interest having a specific origin or a specific correction will become a correction rule for automatic correction. The rule may be incorporated in existing rules such as business rules, organisational policies and/or correction rules.

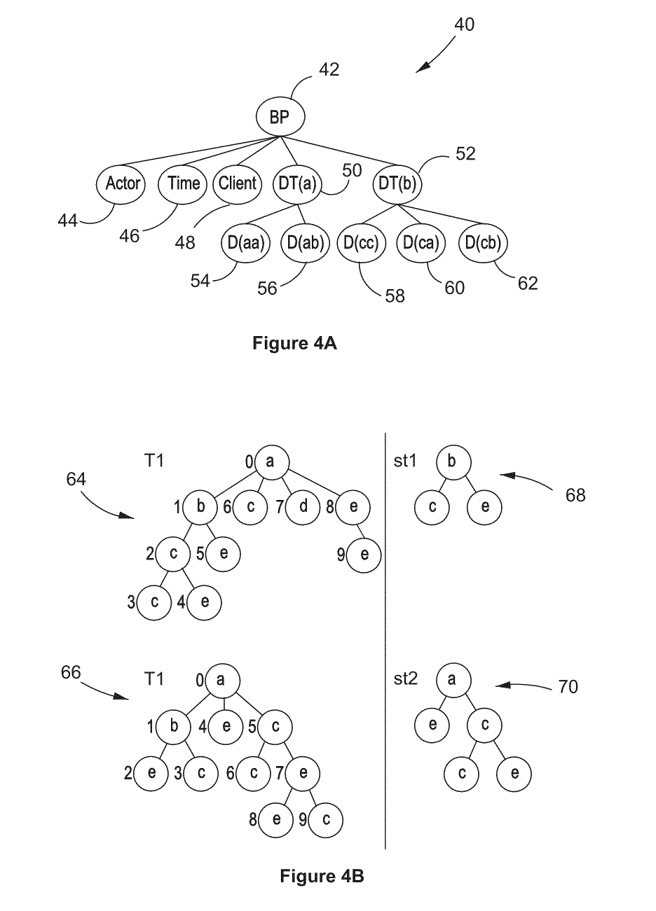

Referring now to FIGS. 4A and 4B, there is shown a schematic representation of the concept of “tree mining”. In accordance with a specific embodiment of the present invention, the concept of “tree mining” is performed in relation to overrides. An override may be the result of a validation alert which may be generated by a computer program in response to a violation of a rule. A system usually allows a user with certain privileges to ignore a validation alert, in which case the data element which is entered is associated with an override.

Many systems collect information regarding business processes which are known as audit logs or event logs. This information typically comprises activities or tasks of the business process, process instances for example organisational aspects or cases being handled (client dealing type/description, customer order, transaction), sectors for example initiators of the process and/or time stamp such as time of process occurrence.

Analysis of business processes can reveal many useful insights into the whole organisational structure and performance such as performance bottlenecks, undesired or unexpected instances such as overrides, interaction between sectors, good/bad performance or differences in the way a business process is executed across sectors/branches. The amount of business processes stored in a system is typically large and automating the analysis may be a significant advantage. Interesting associations are typically those which are unexpected and occur across many instances of a business process such as overrides.

In regard to overrides which are a specific example of an unexpected business process instance, there are two different categories for overrides, in particular a valid override and an invalid override.

For example, a user ignores a validation alert to speed up the execution of a business process. Reasons for that may be a number of invalid validation alerts as a result of inadequate or outdated rules which are still in the computer system and which are frequently overridden.

Hence, users have typically stopped reading the validation alerts. Another reason may be that a user temporarily ignores a validation alert with an intention to correct the corresponding data element, but forgets to correct it. Consequently, the data element associated with the override remains in the system. Another reason may be found in the rules, which expect a certain sequence of actions to execute a business process, although there may be different ways in which a business process can be executed across different branches, sectors or users. For example, when processing a payment, a user may not accept the payment immediately and performs other related actions of a business process in the meantime, but a rule of the computer system expects processing the payment first.

Another type of invalid override may be the result of fraudulent activities. Fraudulent activities correspond to activities where a user is aware of a rule and the corresponding validation alert but overrides it in order to proceed with his or her fraudulent intention. For example, a user may know a client he/she is dealing with and will perform an action without accepting any payment, or may assign concessions to a client when he/she is not entitled to do so.

A valid override typically is a result of an error within the rules or logic of a computer system. A validation alert is communicated to a user although the correct data element is entered into the computer system. This can occur due to outdated rules such as an organisational policy which has not been updated in the computer system correctly. It can also be caused by the lack of flexibility of the computer system. For example, the computer system expects a specific business process to be executed in a certain order. This may not be an error in the computer system but rather be a lack in standardisation of a business process.

The step of comparing a group of interest having data elements comprising at least one data element associated with an override with another group forming a reference group may lead to an origin of the at least one data element associated with the override to identify a resolution strategy. An origin may be identified by analysing at least some of the plurality of groups that may, for example, form execution paths of a business process.

In order to determine another group forming a reference group, the largest frequent group may be identified. However, a person skilled in the art will appreciate that other methods of determining the reference group are envisaged.

A specific example will now be described in accordance with an embodiment of the present invention:

The plurality of records is associated with the business process “add new customer”. In this particular example, a property of each data record in a group is identical to a property of each other data record of that group such as “DealingType(Customer) Description(Customer Search)” which occurs eight times.

The group of interest occurs in 8 data records having an override associated with “add a new customer”:

### DealingType(Customer) Description(Customer Search)

### DealingType(Customer) Description(Add New Customer)

DealingType(Customer) Description(Override: Customer with those details exists)

### DealingType(Customer) Description(Add Application)

### DealingType(Application) Description(Print Approved Appl)

The group forming a reference group occurred 108 times:

### DealingType(Customer) Description(Customer Search)

### DealingType (Customer) . . .

### DealingType(Customer) Description(Add New Customer)

### DealingType(Customer) Description(Add Application)

### DealingType(Application) Description(Print Approved Appl)

With regard to the reference group, it can be seen that the reference group has data records that have respective properties which are identical to properties of respective data records of the group of interest, such as “DealingType(Customer) Description(Customer Search)”, however, some properties are different.

This is an example where a potential duplicate may be introduced. The computer system found a close match for a new customer, but the user ignores the corresponding validation alert. This may be an example of an invalid override, where a duplicate is generated.

Corrections of the group of interest having data elements associated with an override may be incorporated into the rules such as business rules, organisational policies and/or correction rules.

Referring now to FIGS. 4A and 4B, the concept of “tree mining” 40 will be described. Data records entered into a system are often not organised according to a particular business process, but rather stored on a time basis when the data records were entered. For example, a data record such as a financial data record typically comprises a time stamp. Typically, data records have data elements which are repeated in a plurality of data records.

The concept of “tree mining” is a specific type of structured data mining such as XML in which the selected data records are represented in a tree structured format. By using the tree structured format an order and a position in which the plurality of data records and the respective data elements were entered into a computer system is preserved. In this particular embodiment, each data record relates to a business process instance which is represented by a node. Each group of data elements refers to specific actions, activities or business process instances of a business process path such as a sequence of workflow events. Each group is represented as a subtree. Further, the root of the tree is associated with a specific business process.

The data records can then be analysed using common tree mining algorithms. As such, business processes and business process execution paths including corresponding business process instances can be reconstructed from analysing the tree structured format.

Therefore, data records which are associated with specific instances of a business process or specific transactions are identified and grouped. The order of data records within a single business process is preserved as they reflect the workflow of that business process. Using tree mining for analysing data can be used for identifying the sequence of business process instances leading to data elements that are associated with a specific override, or for evaluating operational efficiency. Therefore, the order of data elements and/or data records entered into a system needs to be preserved.

In addition, tree mining may be used for the analysis of a workflow such as the order of executed actions of a business process, conformance of a business process to a rule, identification of overrides and origins causing these or identification of performance bottlenecks, at least.

A business process may have a plurality of data records, the selected data elements of data records associated with a plurality of instances such as a transaction will be represented in a tree structured format in accordance with an embodiment of the present invention as shown in FIG. 4A. The step of comparing a group of interest with a reference group and the step of identifying origins of data elements associated with overrides may be performed using common tree mining algorithms.

For example, selected data elements of data records or entire data records can effectively be grouped in a tree structure format. Therefore, the size of the initial plurality of data records is reduced without losing any information about the data records.

In the following example, each of the five data records is associated with a specific business process instance 42. Each data record comprises the following selected data elements: an actor 44, a time stamp 46, a client 48, client dealing types 50 and 52 and specific descriptions of the dealings 54, 56, 58, 60 and 62.

In this example, the five data records were entered into a system in the following order:
1) Actor ID, time stamp, client ID, dealing type A, description AA
2) Actor ID, time stamp, client ID, dealing type A, description AB
3) Actor ID, time stamp, client ID, dealing type B, description CC
4) Actor ID, time stamp, client ID, dealing type B, description CA
5) Actor ID, time stamp, client ID, dealing type B, description CB

The five data records are associated with one specific business process 42 which may be represented by a “parent” node in a first level of a tree. Identical data elements of the five data records comprise actor ID 44, time stamp 46 and client ID 48. These elements are represented by “child” nodes in a second level of the tree directly connected to the business process 42 of the first level. The identical data element of data records 1 and 2 is the dealing type A which is represented by an additional “child” node in the second level 50. The different descriptions AA and AB are represented by two additional nodes 54 and 56 in a third level of the tree, directly connected to dealing type A. The nodes 50, 54 and 56 for dealing type A 50 and the descriptions AA and AB may form a simple “subtree”. Consequently, a subtree may refer to a group of the plurality of groups having data elements or properties which are similar or identical to data elements or properties, respectively, of each other data record of that group.

A similar structure may be represented for data records 3 to 5 for dealing type B represented by a node 52 in the second level of the tree and descriptions CC, CA and CB which are represented by three nodes 58, 60 and 62 in the third level of the tree. Nodes 52, 58, 60 and 62 may form a subtree.

It will be appreciated by a person skilled in the art that a tree may comprise a plurality of levels and a plurality of subtrees having a plurality of nodes.

The order of the data records is preserved by representing data records in a tree from left to right.

An execution path of a business process or of a transaction may relate to branches of the tree connecting at least two nodes.

A person skilled in the art will appreciate that the example shown in FIG. 4A may alternatively be represented in a sequence structured format using the concept of “sequence mining”.

The rules in accordance with an embodiment of the present invention relate to a sequence of business process instances, actions or events that must be performed in a specific order, any constraints on the execution path of a business process, and/or constraints on allowed properties of data elements.

Referring now to FIG. 4B, an example of two transactions illustrated as trees 64 and 66 and two subtrees 68 and 70 is shown.

In this specific example, the selected data elements are associated with a specific transaction. A transaction may be for example a fragment of the tree describing an independent instance of action; a transaction may also be represented by a tree. A business process comprises at least one transaction.

Each group of the plurality of groups relates to a subtree. In order to identify how frequent a subtree is and subsequently determine a group of interest and a reference group, different support definitions may be used such a “transactional support”, “occurrence-match support” or “hybrid support”.

The “transactional support” of a subtree is equal to the number of transactions that comprise at least one occurrence of the subtree. Therefore, the use of the transaction support will identify frequent business process execution paths.

The “occurrence match support” of a subtree is equal to the number of occurrences of the subtree in all transactions. Therefore, the use of the occurrence match support will take into account the repetition of subtree patterns within a business process instance.

The “hybrid support” counts how often a subtree occurs in each transaction. For example, if a subtree is repeated within a transaction, it may indicate a non-optimal workflow for a specific business process. This may also identify performance bottlenecks.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of analysing data, the method comprising the steps of:
providing a plurality of data records, each data record having a plurality of data elements and having a property;
selecting at least some data elements of each data record;
grouping the selected data elements in a plurality of groups such that each group has data elements that are a part of one of the data records and such that for a group that has data elements of more than one data record, each data element or property is similar or identical to at least one of the data elements or properties, respectively, of each other data record of that group;
determining a group of interest of the plurality of groups, the group of interest having at least one data element of interest;
determining another group of the plurality of groups, the other group forming a reference group having data elements or properties that are similar or identical with data elements or properties, respectively, of the group of interest; and
comparing the group of interest with the reference group such that from the reference group information concerning the data element of interest can be derived.

2. The method as claimed in claim 1 wherein the step of grouping the selected data elements is conducted such that the plurality of groups is associated with a business process.

3. The method as claimed in claim 2 wherein each group is associated with a plurality of instances of the business process.

4. The method as claimed in claim 1 wherein the method is conducted such that one or more business processes associated with the plurality of groups can be reconstructed.

5. The method as claimed in claim 4 wherein the method is conducted such that one or more business rules associated with the one or more business processes can be identified.

6. The method as claimed in claim 1 wherein the at least one data element of interest is associated with an undesired or unexpected process instance.

7. The method as claimed in claim 1 wherein the step of selecting at least some data elements of each data record comprises selecting the entire data record.

8. The method as claimed in claim 1 wherein the data record has a plurality of properties that relate to the respective plurality of data elements.

9. The method as claimed in claim 1 wherein the step of comparing the group of interest with the reference group comprises analysing the information concerning the data element of interest such that an origin or cause of the data element of interest can be identified.

10. The method as claimed in claim 1 wherein the information is indicative of characteristics of a plurality of instances of a business process associated with the group of interest such as characteristics of an execution path of the business process which is formed by the plurality of instances.

11. The method as claimed in claim 1 wherein the step of comparing the group of interest with the reference group comprises determining a correction of the data element of interest.

12. The method as claimed in claim 11 wherein the step of comparing the group of interest with the reference group comprises determining a rule for the correction of the data element of interest.

13. The method as claimed in claim 1, the method comprising an additional step of comparing the group of interest with predetermined rules to analyse if rules associated with the group of interest are violated.

14. The method as claimed in claim 1 wherein the step of comparing a group of interest having at least one data element of interest with a reference group comprises comparing each group of the plurality of groups with each other group of the plurality of groups such that two most similar groups can be identified.

15. The method as claimed in claim 6 comprising an additional step of analysing the information to determine if a rule is violated such that the validity of the undesired or unexpected process instance is determined.

16. The method as claimed in claim 1 being performed using a concept of tree mining.

17. The method as claimed in claim 1 comprising of:
detecting a group of interest having a data element of interest comprising at least one inconsistency; thereafter
correcting the at least one inconsistency; thereafter
detecting duplicates; thereafter
removing duplicates; thereafter
identifying overrides; thereafter
identifying business processes as origins of the identified overrides; and thereafter
correcting the identified business processes and/or remove or update the corresponding validation alert.

18. A computer program arranged when loaded into a computer system to instruct the computer system to operate in accordance with the method of claim 1.

19. A non-transitory computer readable medium for causing a computer system to operate in accordance with the method of claim 1.

20. A method of analysing data, the method comprising the steps of:
providing a plurality of data records, each data record being associated with an instance of a business process and having a property;
grouping the plurality of data records in a plurality of groups such that the plurality of groups is associated with a business process, each group being associated with a plurality of instances of the business process, and the property of each data in a group being similar or identical to a property of each other data record of that group;
determining a group of interest of the plurality of groups, the group of interest having at least one data record of interest which is associated with an undesired or unexpected business process instance;
determining another group of the plurality of groups, the other group forming a reference group having data records that have respective properties which are similar or identical with properties of respective data records of the group of interest; and
comparing the group of interest with the reference group such that from the reference group information concerning the data record of interest and/or the plurality of instances associated with the group of interest can be derived.
